(19) United States
(12) Patent Application Publication
(10) Pub. No.: US 2024/0101174 A1
(43) Pub. Date: Mar. 28, 2024

(54) VEHICLE CONTROL SYSTEM

(71) Applicant: Transportation IP Holdings, LLC, Norwalk, CT (US)

(72) Inventor: Matthew Vrba, Marion, IA (US)

(21) Appl. No.: 18/529,993

(22) Filed: Dec. 5, 2023

Related U.S. Application Data
(63) Continuation-in-part of application No. 18/330,833, filed on Jun. 7, 2023.
(60) Provisional application No. 63/391,181, filed on Jul. 21, 2022.

(51) Int. Cl. B61L 23/14; B61L 25/02

(52) U.S. Cl. CPC B61L 23/14; B61L 25/025; B61L 2201/00; B61L 2205/04

(57) ABSTRACT

Operation of a vehicle system may be controlled by identifying a location of the vehicle system and a confidence measurement of the location that is identified, selecting an operational mode of the vehicle system from among a more restrictive operational mode and a less restrictive operational mode based on the confidence measurement of the location that is identified, and controlling movement of the vehicle system within different limits based on which of the more restrictive operational mode or the less restrictive operational mode that is selected.

### CROSS-REFERENCE TO RELATED APPLICATIONS

This application is a continuation-in-part of and claims priority to U.S. patent application Ser. No. 18/330,833 (filed 7 Jun. 2023), which claims priority to U.S. Provisional Application No. 63/391,181 (filed 21 Jul. 2022), the entirety of which are incorporated herein by reference.

### BACKGROUND

### Technical Field

The subject matter described herein relates to systems that control operation of vehicles.

### Discussion of Art

Many vehicles rely on tracking or knowing locations of the vehicles in controlling movement of the vehicles. For example, many vehicles and different types of vehicles (e.g., automobiles, rail vehicles, buses, trucks, mining vehicles, manned or unmanned aircraft, agricultural vehicles, marine vessels, etc.) may use navigation systems to control when, where, and how the vehicles move along routes between locations.

As one example of such a navigation system, some rail vehicles may use vehicle control systems to control where, when, and/or how the rail vehicles may move to avoid collisions between the vehicles, to avoid moving in unsafe manners (e.g., too fast through curves or through areas where maintenance crews are present, etc.), and the like. One example of such a navigation system is a Positive Train Control (PTC) system. The PTC system includes both off-board and onboard components. Vehicles report positions, speeds, etc. to the off-board component of the PTC system. The off-board component monitors the movements of many vehicles based on these reports, and sends instructions (e.g., movement authorities) that inform the onboard components of which segments of routes that the vehicles can safely enter into, how fast the vehicles can move in different segments of the routes, etc., to prevent collisions and/or ensure the vehicles are otherwise moving in safe ways.

For these control systems to be able to operate, the control systems may require that an initial or starting location of a vehicle be known. For example, the PTC system may need to know which track a rail vehicle is starting a trip. Currently, the control systems may require that a global navigation satellite system (GNSS) signal be received to determine the possible starting location of the vehicle. The GNSS signal can be a signal that includes or represents a geographic position (latitude, longitude, and/or altitude) of the vehicle, and can be obtained by a GNSS receiver (e.g., a Global Positioning System, or GPS, receiver) onboard the vehicle that receives signals from off-board GNSS components (e.g., GNSS satellites).

One issue with requiring and relying on GNSS signals to determine a vehicle location is that there may be locations where GNSS signals are not available or the confidence of locations determined by a GNSS receiver is low. For example, a vehicle may not be able to determine or report a GNSS-based location or the location may have a low degree of confidence while the vehicle is located in or below structures such as underground stations, platforms with metal awnings, stations under buildings, parking lots, underpasses, trenches, tunnels, etc. The confidence may be a measure of how certain the receiver is about the position or geographic location of the receiver based on the GNSS signals that are received.

Some control systems may be able to rely on the last known location of the vehicles, such as the last reported location of a vehicle when the vehicle ended the prior trip. There are, however, limitations on when the last known location can be stored and used for a new trip, including the lack of a quality wheel tachometer and movement of the vehicle since the prior trip. Additionally, there may be times when the vehicle is a multi-vehicle system formed from several vehicles, and control of the multi-vehicle system may switch from one vehicle (e.g., a locomotive at one end of a train) to another vehicle (e.g., a locomotive at the opposite end of the train). As these controlling vehicles are necessarily in different locations, the last known location of the prior controlling vehicle may not be useful for initiating control by the control system when the next trip begins.

While some known control systems may rely on the addition of sensors, new signals and/or sources of those signals to determine locations of vehicles in GNSS dark areas (areas where GNSS signals cannot be received from the off-board sources), these other known control systems may increase the cost and complexity of operating the vehicles. It may be desirable to have a vehicle control system and method that differs from those that are currently available.

### BRIEF DESCRIPTION

In one example, a method for controlling operation of a vehicle system may include identifying a location of the vehicle system and a confidence measurement of the location that is identified, selecting an operational mode of the vehicle system from among a more restrictive operational mode and a less restrictive operational mode based on the confidence measurement of the location that is identified, and controlling movement of the vehicle system within different limits based on which of the more restrictive operational mode or the less restrictive operational mode that is selected.

In another example, a control system can include one or more processors that can receive or determine a location of a vehicle system and a confidence measurement of the location that is received or determined. The processor(s) can select either a more restrictive operational mode or a less restrictive operational mode for the vehicle based on the confidence measurement. The processor(s) can restrict movement of the vehicle system within different limits based on which of the more restrictive operational mode or the less restrictive operational mode that was selected.

In another example, another method for controlling a vehicle system can include calculating a confidence value of an identified location of a vehicle. The confidence value can indicate a certainty that the vehicle is at the identified location. The method can include selecting a first operational mode or a second operational mode based on the confidence value, and restricting movement of the vehicle to within different limits based on which of the first operational mode or the second operational mode was selected.

### BRIEF DESCRIPTION OF THE DRAWINGS

The subject matter may be understood from reading the following description of non-limiting embodiments, with reference to the attached drawings, wherein below:

FIG. 1 illustrates one example of a network of routes extending into and/or through a blocking structure;

FIG. 2 illustrates one example of a vehicle control system;

FIG. 3 illustrates one example of route selection for reporting to an off-board component of a positive (or negative) control system during or for trip initialization;

FIG. 4 illustrates another example of route selection for reporting to the off-board component of the positive (or negative) control system during or for trip initialization;

FIG. 5 illustrates another example of route selection for reporting to the off-board component of the positive (or negative) control system during or for trip initialization;

FIG. 6 illustrates a flowchart of one example of a method for determining locations of vehicles; and

FIG. 7 illustrates a flowchart of one example of a method for controlling a vehicle.

### DETAILED DESCRIPTION

Embodiments of the subject matter described herein relate to vehicle control systems and methods that determine locations of vehicles. This may occur in areas where the vehicles may be unable to accurately (e.g., correctly) and/or precisely (e.g., with an acceptable range of error or with an acceptable confidence measurement) determine the locations of the vehicles. These determined locations may then be used by the vehicle control systems to assist the vehicles in safe movement, such as by instructing onboard components of the vehicle control systems when, where, and/or how the vehicles can safely travel through or on different segments of routes. In one embodiment, the vehicle control system and method may rely on existing components already onboard a vehicle to determine locations (e.g., initial locations before a trip is begun) without having to add more components, rely on additional signals from an off-board source, etc.

As one example, existing navigation devices may operate in conjunction with GNSS receivers to determine locations of vehicles in the absence of GNSS signals. For example, an inertial measurement unit (IMU) and/or wheel speed sensor can provide inputs used to determine geographic positions after losing GNSS signals from off-board sources (e.g., GNSS satellites). This geographic position or location can be determined based on the inertial data output by the IMU and a previously determined (e.g., the last known) GNSS geographic position or location. For example, the navigation device can measure the heading and speed of the vehicle. Based on this heading and speed at which the vehicle moves from the last known GNSS-derived location, the current or new location of the vehicle (e.g., in or within an area where GNSS signals cannot be received) can be determined. This location can be reported to the vehicle control system and used to begin monitoring the movement of the vehicle (for creating movement authorities or other restrictions that ensure that safe movement of that vehicle and other vehicles).

In situations where the vehicle control system is starting or initializing for a new trip, the vehicle control system may use the geographic location of the vehicle that is determined from the navigation device in the absence of GNSS signal reception to determine the possible route locations where the vehicle might be located. Optionally, the navigation device can calculate a position error (e.g., a standard deviation or other error calculation) that indicates several possible locations (e.g., an area) where the vehicle may be located based on the last known GNSS location and the information measured by the navigation device (e.g., heading and moving speed since the last known GNSS location was determined). This error may extend over or encompass one or more routes. For example, the error may be represented by a circle, sphere, or other shape that overlaps with one or more routes (e.g., on a two-dimensional or three-dimensional map).

Depending on the number of routes that the error overlaps, the off-board and/or onboard components of the vehicle control system may automatically identify the route on which the vehicle is located, may select a set of routes for presentation to one or more onboard operators for selection of which route the vehicle is located on, or may determine that the component(s) are unable to automatically identify or select a set of routes for presentation to the operator(s). For example, if the error bounds (e.g., the circle, sphere, or other shape) overlaps a single route, the system may automatically select the route on which the vehicle is located (as that single route). If the error bounds overlap multiple routes (e.g., two or more neighboring parallel tracks, lanes of a road, parallel roads, etc.), then the system may present a list or map of these routes that overlap with the error bounds for presentation and selection by the operator(s).

In one example, if the error bounds overlap many routes (e.g., more than a threshold number, such as three in one embodiment), then the system may determine that the system is unable to identify the route on which the vehicle is located. Alternatively, if the error bounds overlap many routes (e.g., more than the threshold number), then the system may still present these routes that overlap the error bounds for presentation and selection by the operator(s). With the route on which the vehicle is located being selected, the off-board components of the vehicle control system may begin tracking movements of the vehicle. This allows the vehicle control system to warn or restrict movements of other vehicles based on movements of the vehicle having the selected route, as described herein.

Optionally, the control system may examine a confidence measurement of the location that is determined of a vehicle system. This location may be determined using GNSS, but optionally the location may be determined without use of GNSS signals, such as using signals or inputs from an IMU or wheel speed sensor. The control system can select an operational mode of the vehicle based on this confidence measurement. As one example, this operational mode may be a restricted mode or a more restrictive mode in which movement of the vehicle system is restricted by the control system to within tighter or more restrictive limits unless or until the confidence measurement of the GNSS-determined location exceeds a threshold, such as a designated, set, previously determined, etc. confidence threshold. Another operational mode may be an unrestricted or less restrictive mode in which the movement of the vehicle system is either unrestricted or is restricted to broader or less restrictive limits. This mode may be entered when the confidence measurement is greater.

The confidence measurement may be a numerical value indicative of how certain the GNSS receiver is about the geographic location determined by that receiver. The confidence measurement may be expressed as a percentage with higher percentages representing higher confidence in the location of the GNSS receiver. The confidence measurement may be impacted by factors such as the number of satellites from which the GNSS signals are received by the GNSS receiver, the quality of these signals, the presence of obstructions (blocking structures such as buildings or tunnels, trees, valleys, etc.), atmospheric conditions, or the like.

As described above, the vehicle control system may identify the route on which the vehicle is located based on the GNSS-determined location. The control system may recommend or automatically select the route that the control system believes or determines that the vehicle is located on. The control system can select the restricted operational mode and restrict movement of the vehicle unless or until the confidence measurement of the GNSS-determined location exceeds a threshold. For example, the control system may not allow the vehicle to travel over a reduced speed limit unless or until the confidence measurement of the GNSS-determined location increases above the threshold. As another example, the control system may select the restricted operational mode and require a longer stopping distance than the unrestricted operational mode. The control system may then prevent or disallow control of the vehicle that would prevent the vehicle from moving within this longer stopping distance to other vehicles or other objects (unless or until the confidence measurement exceeds the threshold). Once the confidence measurement exceeds the threshold, the control system may switch operation to the unrestricted mode. In this mode, the control system may require a shorter stopping distance than the restricted operational mode. The control system can then allow the vehicle to move closer to the other vehicles or objects without slowing or stopping when compared with the restricted operational mode.

The confidence measurement and the GNSS-determined location may be repeatedly calculated by the GNSS receiver and/or vehicle control system. The movement of the vehicle may be restricted by preventing the vehicle from moving faster than the reduced speed limit, which may be slower than a legislated or regulated speed limit of the route and/or which may be slower than the fastest speed that the vehicle can move. The control system may disregard or change operator inputs to the controls of the vehicle that would result in the vehicle violating the restrictions on movement. In contrast to other embodiments, the control system may allow the vehicle to move, but with a reduced speed until the GNSS-determined location has a confidence measurement that exceeds the threshold.

The operational mode selected by the control system may be based solely on the confidence measurement or may be selected based on the confidence measurement and one or more additional factors. These factors may include the confidence of the route selection, the type of cargo being carried by the vehicle, the population density nearby and/or through which the vehicle is scheduled or expected to travel, the traffic density nearby and/or through which the vehicle is scheduled or expected to travel, the presence of intersections or crossings between the route on which the vehicle is located or expected to travel and other routes, and/or the number of other nearby routes. The confidence of the route selection may be a measurement or value assigned to the route that is selected based on the GNSS-derived location. For example, routes selected using only the GNSS-derived location may have a lower confidence than routes selected using a combination of the GNSS-derived location and operator input. The confidence of the route selection may be impacted by the confidence measurement of the GNSS-determined location. For example, routes selected using GNSS-determined locations with confidence measurements that are below the threshold may have lower confidences than routes selected using GNSS-determined locations with higher confidence measurements.

The type of cargo being carried by the vehicle can indicate whether the vehicle is carrying hazardous cargo (explosive, corrosive, poisonous, or radioactive materials) that poses a health risk to people, livestock, or vegetation, is carrying people, is not carrying any of the aforementioned types of cargo (non-person and non-hazardous cargo), or is not carrying any cargo. The operational mode may be selected as the restricted mode while the vehicle is carrying hazardous cargo or people. This can restrict the vehicle to travel slower and/or be able to stop faster in areas where there is increased risk of damage to persons, livestock, or vegetation if an accident were to occur and the cargo dumped off the vehicle. The operational mode may be selected as the unrestricted mode while the vehicle is not carrying hazardous cargo, is not carrying people, and/or is not carrying any cargo.

The population density may be the density of persons living or currently within a geographic area in which the vehicle is located or expected/scheduled to travel. The operational mode may be selected as the restricted mode responsive to the vehicle being in or expected to travel through an area with a population density that exceeds a population density threshold. This can restrict the vehicle to travel slower and/or be able to stop faster in areas where there is increased risk of collisions with people. The operational mode may be selected as the unrestricted mode responsive to the vehicle not being located in and/or not expected to travel through an area with a population density that exceeds the population density threshold.

The traffic density may be the density of other vehicles within a geographic area in which the vehicle is located or expected/scheduled to travel. The operational mode may be selected as the restricted mode responsive to the vehicle being in or expected to travel through an area with a traffic density that exceeds a traffic density threshold. This can restrict the vehicle to travel slower and/or be able to stop faster in areas where there is increased risk of collisions with people. The operational mode may be selected as the unrestricted mode responsive to the vehicle not being located in and/or not expected to travel through an area with a traffic density that exceeds the traffic density threshold.

The operational mode may be selected as the restricted mode responsive to the vehicle being on or expected to travel on a route having at least a designated number of intersections or crossings. This can restrict the vehicle to travel slower and/or be able to stop faster in areas where there is increased likelihood of other vehicles crossing in the vehicle. The operational mode may be selected as the unrestricted mode responsive to the vehicle not being on or expected to travel on a route having at least the designated number of intersections or crossings.

The operational mode may be selected as the restricted mode responsive to the number of nearby routes exceeding a route threshold. For example, if the GNSS-determined location is within a threshold distance (e.g., twenty meters) of more than the route threshold number of routes, then the control system may select the restricted mode of operation. This can restrict the vehicle to travel slower and/or be able to stop faster in areas where there is increased risk of the incorrect route being selected as the route the vehicle is located on. The operational mode may be selected as the unrestricted mode responsive to the vehicle not being within the threshold distance of more than the number of routes in the route threshold.

The confidence threshold may have a static, default value, or may have a changeable value that an operator or the control system can change. The control system can change the confidence threshold based on one or more factors. These factors may include the confidence of the route selection, the type of cargo being carried by the vehicle, the population density nearby and/or through which the vehicle is scheduled or expected to travel, the traffic density nearby and/or through which the vehicle is scheduled or expected to travel, the presence of intersections or crossings between the route on which the vehicle is located or expected to travel and other routes, and/or the number of other nearby routes. For lower confidences in the route selection, the confidence threshold may be increased relative to greater confidences in route selection to ensure that the vehicle is restricted in movement while there is a higher risk that the selected route is incorrect. For hazardous cargo or passengers being carried by the vehicle, the confidence threshold may be increased relative to non-hazardous cargo, no cargo, and/or no persons being carried to ensure that the vehicle is restricted in movement while there is greater risk should an accident occur. For greater population densities or traffic densities, the confidence threshold may be increased relative to lesser densities to reduce the risk of an accident involving the vehicle. The confidence threshold may be increased while the vehicle or route expected to be traveled has more intersections or crossings, or is closer to other routes, relative to fewer intersections/crossings or fewer other routes nearby to reduce the risk of accident and/or negative impacts from an incorrect route selection.

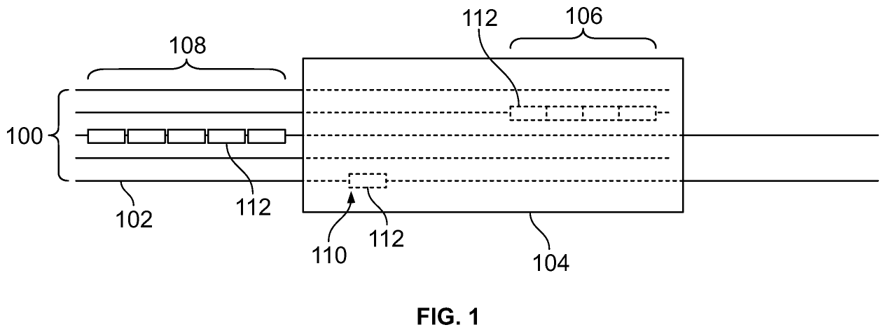

FIG. 1 illustrates one example of a network 100 of routes 102 extending into and/or through a blocking structure 104. The routes can represent roads, tracks, lanes of the same or neighboring roads, paths, waterways, or other vehicle routes on which vehicle systems 106, 108, 110 may travel. The vehicle systems can represent a single vehicle 112 (e.g., the vehicle system 110) or multi-vehicle systems (e.g., the vehicle system 106 and/or 108) formed from multiple vehicles. The vehicles in the multi-vehicle system can be mechanically coupled with each other or may remain separate but coordinate movements so that the vehicles in the vehicle system move together (e.g., in a platoon, convoy, swarm, etc.). The vehicles can be propulsion-generating vehicles (e.g., automobiles, trucks, locomotives, etc.). In the multi-vehicle systems, one or more (but fewer than all) of the vehicles can represent non-propulsion-generating vehicles (e.g., trailers, railcars, etc.). The structure can represent any man-made or natural object that can interfere with, or block reception of location signals sent by off-board sources (e.g., GNSS satellites). For example, the structure can represent a building, parking lot, canopy, tunnel, ravine, valley, mountain, trees, etc. that partially or entirely block transmission of GNSS satellites to GNSS receivers onboard the vehicle systems. As another example, the blocking structure can represent a non-physical blocking or impedance to transmission of the GNSS signals. For example, GNSS signals may be blocked through GNSS jamming where other signals are intentionally or unintentionally transmitted and jam or otherwise interfere with transmission of the GNSS signals. The vehicles may be unable to receive the GNSS signals while the vehicle systems are beneath or within the structure (e.g., or within an area where other signals are jamming or interfering with the GNSS signals).

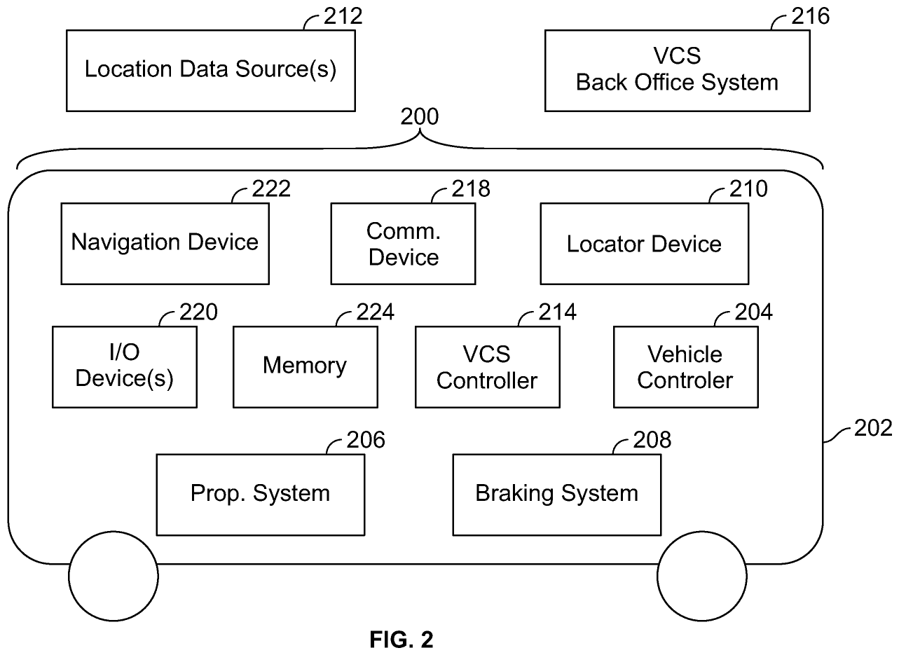

With continued reference to the vehicle systems and structure shown in FIG. 1, FIG. 2 illustrates one example of a vehicle control system 200. The vehicle control system may be off-board and/or onboard a vehicle 202, such as a propulsion-generating vehicle. The vehicle shown in FIG. 2 can represent one or more of the vehicles in the vehicle systems shown in FIG. 1. One or more components of the vehicle control system may be off board the vehicle while one or more other components of the vehicle control system may be onboard the vehicle. Alternatively, all components of the vehicle control system may be onboard the vehicle.

A vehicle controller 204 controls the operation (e.g., movement) of the vehicle. The vehicle controller can represent hardware circuitry that includes and/or is connected with one or more processors (e.g., microprocessors, integrated circuits, field programmable gate arrays, etc.) that perform the operations described in connection with the vehicle controller. For example, the vehicle controller can communicate with a propulsion system 206 (“Prop. System” in FIG. 2, such as one or more engines, motors, or the like) to control propulsion of the vehicle and vehicle system, and/or a braking system 208 (e.g., one or more friction brakes, air brakes, or the like) to slow or stop movement of the vehicle and vehicle system.

A locator device 210 may determine the geographic locations of the vehicle. In one embodiment, the locator device communicates with one or more location data sources 212 that are off board the vehicle to determine the locations of the vehicle. For example, the location data sources can represent GNSS satellites or beacons that broadcast signals that are received by the locator device (e.g., a GNSS or GPS receiver). The locator device can calculate the location, heading, speed, etc. of the vehicle based on these signals, as well as a confidence measurement of the location that is calculated from the received signals. Alternatively, the locator device can include a sensor that detects one or more characteristics to determine the locations of the vehicle. For example, the locator device can represent a radio frequency identification (RFID) reader that reads an RFID tag associated with a known location to determine the vehicle location. As another example, the locator device can represent an optical sensor, such as a camera, that optically reads where the vehicle is located (e.g., from one or more signs, such as waypoints, road signs, etc.). In one example, the locator device (and/or the vehicle controller) can apply one or more filters to the signals received from the location data source(s), such as a Kalman filter.

A vehicle control system controller 214 (“VCS Controller” in FIG. 2) represents an onboard component of the vehicle control system. The VCS controller can communicate with an off-board component of the vehicle control system, such as a vehicle control system back-office system 216 (“VCS Back Office System” in FIG. 2). The VCS controller and the back-office system can communicate with each other via a communication device 218 (“Comm. Device” in FIG. 2), which can represent hardware transceiving circuitry, such as a transceiver, modem, antenna, and the like. The back-office system also can include a communication device 218 to allow for communication with the vehicles. The VCS controller can represent hardware circuitry that includes and/or is connected with one or more processors. The VCS controller can communicate with the back-office system to report locations of the vehicle, moving speeds of the vehicle, headings or directions of movement of the vehicle, etc. The VCS controller also can receive directive signals from the back-office system. These signals can include movement restrictions, such as movement authorities that dictate where, when, and/or how the vehicle can move. The back-office system can determine whether to allow different vehicles to enter into different route segments and/or how the vehicles can move in those segments based on reported locations, speeds, and/or headings of the vehicles, as well as reported areas of the routes undergoing repair, maintenance, etc.

For example, the back-office system and the VCS controller can be components of a positive control system that sends movement authorities to vehicles to inform the vehicles whether the vehicles can travel into an upcoming segment of a route, how fast the vehicles can move in the upcoming segment of the route, etc. If the VCS controller receives a permissive movement authority from the back office system indicating that the vehicle can enter into the upcoming segment, then the VCS controller can inform the operator (e.g., via an input and/or output device 220, or “I/O Device” in FIG. 2) of whether the vehicle can move into the upcoming segment (and optionally how fast the vehicle can move in the upcoming segment). Optionally, the VCS controller can allow the vehicle to move into the upcoming segment responsive to receiving the movement authority. But if the VCS controller does not receive the movement authority, then the VCS controller may inform the operator of the vehicle and/or generate signals to automatically control the propulsion system and/or braking system to prevent the vehicle from entering into the upcoming segment of the route and/or to prevent the vehicle from moving in the upcoming segment of the route in a way that violates the movement authority (e.g., moving faster than the movement authority dictates).

As another example, the back-office system and the VCS controller can be components of a negative control system that sends movement authorities to vehicles to inform the vehicles where the vehicles cannot travel. If the VCS controller receives a movement authority from the back-office system indicating that the vehicle cannot enter into the upcoming segment, then the VCS controller can inform the operator and/or automatically control the propulsion system and/or braking system to prevent disallowed movement of the vehicle in the upcoming segment. If the VCS controller does not receive the movement authority from the back-office system indicating that the vehicle cannot enter into the upcoming segment, then the VCS controller can inform the operator and/or allow movement of the vehicle in the upcoming segment.

A navigation device 222 can determine locations of the vehicle based off information other than or in addition to the off-board signals received from the location data source(s). For example, the navigation device can include or represent one or more sensors that detect movement of the vehicle. These sensors can include one or more IMUs, accelerometers, magnetometers, tachometers (e.g., wheel and/or other tachometers), etc. The navigation device optionally can include one or more processors that examine the information sensed by the sensors to determine the movement and/or change in location of the vehicle. Alternatively, the navigation device may include the sensor(s) but may send the output from the sensor(s) to the VCS controller and/or the vehicle controller to calculate the location of the vehicle based on the sensor output. The navigation device and/or the vehicle controller can apply one or more filters, such as a Kalman filter, to the output of the sensor(s). In one embodiment, the navigation device (or the controller(s)) can employ a dead reckoning calculation, a wireless triangulation calculation, or the like, to monitor or determine the location(s) of the vehicle in locations and/or during times when the locator device is unable to do so and/or the locator device is unable to receive the signals from the location data source(s).

The I/O device referred to above can represent a display screen, a touchscreen, a speaker, or the like, which is used to communicate information with an operator onboard the vehicle. A tangible and computer-readable storage medium (e.g., a computer hard drive, disc, removable memory, etc.), or memory 224, optionally can be onboard the vehicle. This memory can store information determined by the navigation device, controller(s), and/or locator device, such as a last-known location determined from the off-board signals received from the location data source(s), the location determined by the navigation device or controller(s) based on the output from the navigation device (e.g., the dead-reckoning determined location), or the like. The memory optionally can store route layouts, such as a map or other information on the locations, curves, paths, etc. of various routes on which the vehicle may or will travel.

In operation, the control system can initiate a trip of the vehicle (or a multi-vehicle system that includes the vehicle) by obtaining one or more off-board signals from the location data source(s) and determine the geographic location of the vehicle. The VCS controller can examine this location and the route layouts (e.g., as obtained from the memory and/or received from a communication from the back-office system) to determine which route the vehicle is located. For example, the VCS controller can determine whether the geographic location of the vehicle as determined by the locator device is on or near a route (e.g., within a threshold distance, such as three meters or a distance between neighboring routes). The VCS controller can identify this route as the route currently occupied by the vehicle and on which the vehicle will begin the trip. The VCS controller can communicate this identified route to the back-office system so the back-office system can determine where the vehicle is located to determine which route segments that the vehicle can enter into, how fast the vehicle can move through the route segments, and the like.

During movement of the vehicle, the vehicle may enter the blocking structure described above. This can impede or prevent the locator device from being able to receive signals from the location data source(s) and, therefore, determine the location of the vehicle. If the vehicle is pausing or ending a trip in the blocking structure, then the locator device may be unable to determine the location of the vehicle when the next trip begins. This can prevent the VCS controller from reporting the location of the vehicle to the back-office system, which can result in the back-office system being unable to determine where the vehicle is located, and which route the vehicle is beginning a trip on. Consequently, the back-office system may not be able to inform the VCS controller of which route segments to travel on and/or how fast to move. In short, the back-office system may not be able to provide the protection that the back-office system would be able to if the starting location of the vehicle was known.

To prevent this from occurring, the navigation device, VCS controller, and/or vehicle controller can determine a last-known location of the vehicle from the locator device before the locator device is unable to determine the location of the vehicle. For example, prior to entering the blocking structure, the locator device may provide a geographic location of the vehicle outside of the blocking structure. This last-known location may be a location that is just outside the blocking structure (e.g., within ten meters of an exterior of the blocking structure) or farther from the blocking structure.

The navigation device, VCS controller, and/or vehicle controller can use this last-known location, as well as the speed and/or heading of the vehicle (as determined by the navigation device), to calculate one or more additional locations of the vehicle within the blocking structure. The navigation device, VCS controller, and/or vehicle controller can use dead-reckoning calculations to approximate the location of the vehicle within the blocking structure. The location of the vehicle determined from the locator device can be referred to as the sensed location due to the location being determined based off signals sensed (e.g., received) from off-board or external locations, such as the location data source(s). The location(s) of the vehicle that is or are determined from the output from the navigation device (e.g., the location(s) determined using dead reckoning) may be referred to as calculated locations as these locations are calculated by the vehicle (based off of output from a device onboard the vehicle, such as the navigation device). The VCS controller, navigation device, and/or vehicle controller can calculate the calculated locations until the vehicle stops within the blocking structure or can calculate the calculated location once the vehicle has stopped within the blocking structure.

This calculated location (or the last calculated location) can then be used to initialize the VCS controller for controlling movement of the vehicle during a subsequent trip. For example, prior to the vehicle or vehicle system beginning another trip starting inside the blocking structure, the vehicle or vehicle system may need to communicate the starting location and/or identification of the route on which the vehicle or vehicle system is located. This information is received by the back-office system, and the back-office system can send a confirmatory signal to the VCS controller to notify that controller that the location and movement of the vehicle or vehicle system is being tracked by the back-office system. This confirms that the back-office system can continue to issue signals to the vehicle to ensure the safe movement of the vehicle (or vehicle system that includes the vehicle).

In one embodiment, the memory may store route locations and layouts, including those routes inside a blocking structure. The VCS controller, vehicle controller, and/or navigation device can automatically select the route on which the vehicle (or vehicle system) is located based on the calculated location of the vehicle (e.g., that is determined after the vehicle has stopped). For example, the VCS controller can select the route from among several routes based on which route the calculated location is disposed. Optionally, one or more routes may be recommended for selection by an operator (and for reporting to the back-office system during trip initialization) based on the calculated location that is determined. For example, the VCS controller can identify one or more routes that are near (e.g., within a threshold distance, such as an error bound or standard deviation) of the calculated location. These routes may be potential routes for selection, and can be presented to an operator (e.g., via the I/O device) for selection.

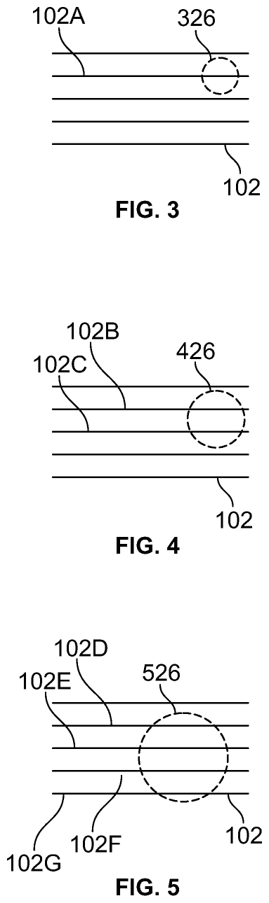

FIGS. 3 through 5 illustrate different examples of route selection for reporting to the back-office system during or for trip initialization. In each of these examples, there are several nearby routes that may be within the blocking structure. A circle 326, 426, 526 in each of FIGS. 3 through 5 indicates the error range of the location of the vehicle that is calculated using the last known sensed location, along with the output from the navigation device. For example, these circles can represent the standard deviation or designated number of standard deviations (e.g., two or three standard deviations) of the calculated location based on the dead reckoning calculation used to calculate the stopping location of the vehicle. The circle in FIG. 3 is smaller than the circle in each of FIG. 4 and FIG. 5, while the circle in FIG. 5 is the largest of the circles in FIGS. 3 through 5. This can indicate that the estimated amount of error of the calculated location is greatest in the example of FIG. 3 and the lowest in the example of FIG. 5.

There can be different error ranges for different calculated locations due to a variety of factors. One example of a factor is the speed at which the vehicle was moving after the last known sensed location was determined (with the size of the error increasing for faster speeds and decreasing for slower speeds). Another example of a factor is the number or magnitude of accelerations or decelerations of the vehicle after the last known location was determined (with the size of the error increasing for greater and/or more frequent accelerations or decelerations and decreasing for smaller and/or fewer accelerations or decelerations). Another example of a factor is the number or magnitude of turns of the vehicle after the last known location was determined (with the size of the error increasing for more turns and/or sharper turns and decreasing for fewer and/or less sharp turns).

In the example of FIG. 3, the VCS controller, the vehicle controller, and/or the navigation device can determine that the vehicle (or vehicle system) is located on a selected route 102A of the routes. This route is selected as the error bounds (e.g., the circle in FIG. 3) extends over only a single route. This route may be automatically selected by the controller(s) and/or navigation device, and reported to the back-office system, without operator intervention in one example. Optionally, this route may be automatically selected by the controller(s) and/or navigation device, presented to the operator, and reported to the back-office system once the operator confirms the selected route (e.g., via the I/O device).

In the example of FIG. 4, the VCS controller, the vehicle controller, and/or the navigation device can determine that the vehicle (or vehicle system) is located on one of several potential routes 102B, 102C. These routes may be selected as potential routes due to the error bounds (e.g., the circle in FIG. 4) extending over these two routes. These routes may be presented to the operator, and the operator can select the route 102B or 102C from these presented routes for reporting to the back-office system. This can reduce the potential for human error by requesting that the operator select the route from a thinned down or reduced list of potential routes based on the calculated location and the error bounds extending around the calculated location.

In the example of FIG. 5, the VCS controller, the vehicle controller, and/or the navigation device can determine that the vehicle (or vehicle system) is located on one of several potential routes 102D, 102E, 102F, 102G. These routes may be selected as potential routes due to the error bounds (e.g., the circle in FIG. 5) extending over these two routes. These routes may be presented to the operator, and the operator can select the route 102D, 102E, 102F, or 102G from these presented routes for reporting to the back-office system. This can reduce the potential for human error by requesting that the operator select the route from a thinned down or reduced list of potential routes based on the calculated location and the error bounds extending around the calculated location.

The vehicle controller and the VCS controller can then begin a new trip with the vehicle or vehicle system identified as starting on the automatically selected route, or the route selected by an operator from an automatically selected list of routes. While one embodiment described herein relates to using the calculated location (and error bounds) for establishing protection by the back-office system (such as a PTC system), not all embodiments are limited to back-office system operation, PTC systems, rail vehicles, or the like. For example, the inventive subject matter described herein may be used in connection with other vehicles (e.g., automobiles), trucks, mining vehicles, marine vessels, or the like, to calculate potential locations of the vehicles using both sensed and calculated locations (e.g., in areas where the signals from the location data sources are not available).

In one embodiment, the control system may have a local data collection system deployed that may use machine learning to enable derivation-based learning outcomes. The controller(s) may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the controller(s) may include a policy engine that may apply to one or more policies. These policies may be based at least in part on characteristics of a given item of equipment or environment. With respect to control policies, a neural network can receive input of a number of environmental and task-related parameters. These parameters may include an identification of a determined trip plan for a vehicle group, data from various sensors, and location and/or position data. The neural network can be trained to generate an output based on these inputs, with the output representing an action or sequence of actions that the vehicle group should take to accomplish the trip plan. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the outputs from the various models are obtained, they may be evaluated on their performance using a determined success metric. The best model is selected, and the vehicle controller executes that plan to achieve the desired input data to mirror the predicted best outcome scenario. Additionally, the success metric may be a combination of optimized outcomes, which may be weighed relative to each other.

The controller(s) can use this artificial intelligence or machine learning to receive input (e.g., a sensed location, moving speed of the vehicle, heading and/or change in heading of the vehicle, etc.), use a model that associates inputs or combinations of inputs with different calculated locations, different error bounds, and/or different routes within a blocking structure to select a calculated location, error bound, and/or route, and then provide an output (e.g., the calculated location, error bound, and/or route selected using the model). The controller(s) may receive additional input or feedback, such as an actual error or difference between the calculated location and actual location of the vehicle, the actual route on which the vehicle is located, etc. Based on this additional input, the controller(s) can change the model, such as by changing which calculated location, error bound, and/or route would be selected when a similar or identical input is provided the next time or iteration. The controller(s) can then use the changed or updated model again to calculate the calculated location, calculate an error bound, select a route, etc., receive feedback on the selected location/error/route, change or update the model again, etc., in additional iterations to repeatedly improve or change the model using artificial intelligence or machine learning.

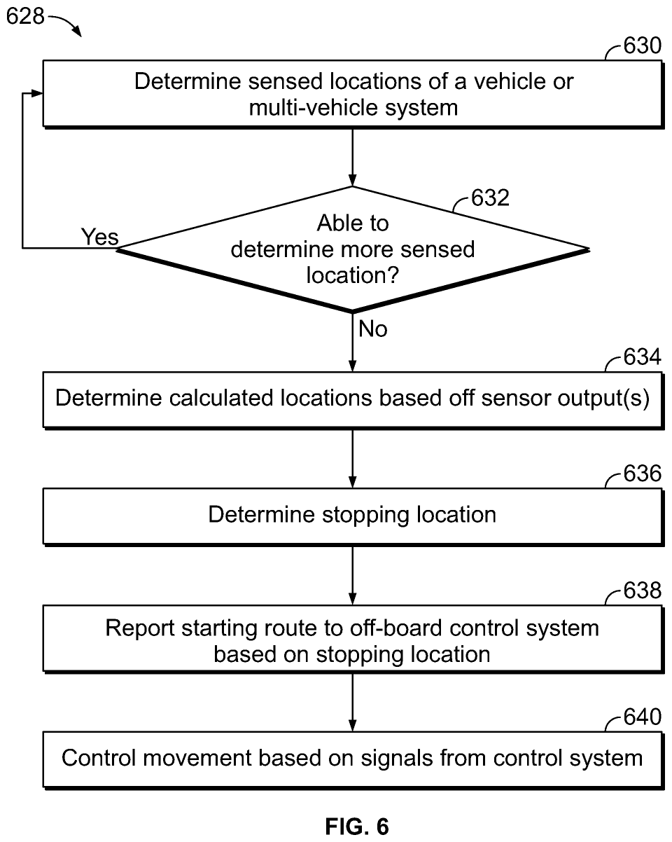

FIG. 6 illustrates a flowchart of one example of a method 628 for determining locations of vehicles. The method can represent operations performed by the control system shown in FIG. 2 to determine locations of vehicles while the vehicles are in locations where external signals (e.g., GNSS signals from the location data sources) may not be available or received. At step 630, one or more sensed locations of the vehicle are determined. These locations can be determined (e.g., calculated) using signals received from off-board sources, such as satellite signals. Alternatively, these locations may be sensed using one or more sensors such as cameras (e.g., reaching or optically detecting location), RFID devices, etc.

At step 632, a determination is made as to whether the vehicle is unable to determine locations of the vehicle from the off-board sources. For example, a decision may be made as to whether the vehicle can continue to sense or determine locations based on signals received from the off-board sources (e.g., satellites). If the vehicle can no longer determine its location from the signals sent by off-board sources (or by sensing objects outside of the vehicle), then the vehicle may no longer be able to determine its sensed location. As a result, flow of the method can proceed toward step 634. If the vehicle can still determine its location from the signals sent by the off-board sources, then the vehicle can continue to determine its location from the signals sent by the off-board sources. As a result, flow of the method can return toward step 630 or may terminate.

At step 634, locations of the vehicle are determined based on output from one or more sensors (e.g., a navigation device). For example, one or more locations of the vehicle may be determined by sensing the speed, heading, vibration, etc. of the vehicle and using a dead reckoning calculation. This can allow for the locations of the vehicle to be determined even though the signals from the off-board sources may not be able to be used for determining the vehicle location. For example, the vehicle can use one or more inertial measurement sensors or units for tracking movements of the vehicle and can calculate locations of the vehicle using dead reckoning.

At step 636, the vehicle may determine the final or stopping location of the vehicle from a completed trip. For example, the VCS controller, vehicle controller, and/or navigation device can determine whether the vehicle has stopped and can calculate the stopped location of the vehicle using the information determined at step 634.

At step 638, a location is reported from the vehicle to an off-board system, such as the back-office system, for protective monitoring of the vehicle. For example, the route on which the vehicle is located may be reported to the back-office system. This route can be selected based on the calculated location of the vehicle (e.g., determined at step 636), as described above. Optionally, several routes may be presented for selection to an operator of the vehicle based on the location determined at step 636, as described above. The selected route may represent the location of the vehicle or vehicle system.

At step 640, movement of the vehicle or vehicle system is controlled based on signals received from the back-office system (that are, in turn, based on the location reported at step 638). For example, the VCS controller may automatically slow or stop movement of the vehicle, may control steering of the vehicle, or the like, based on signals received from the back-office system, as described above. Flow of the method may return to one or more operations or may terminate.

In one example, the VCS controller and/or the vehicle controller can select the operational mode of the vehicle based on the confidence measurement of the location determined by the locator device. The VCS back office system can support the ability to automatically determine an initial route location of the vehicle when the control system starts up, activates, or initializes if the available data results in the control system being able to determine the route location with a high enough confidence level (a confidence measurement that exceeds the confidence threshold). When determined with a high enough confidence level, it may be safe for the vehicle to operate with protection provided by the VCS back office system.

If the initial route location cannot be determined automatically with a high enough confidence, some known back office systems may require an operator to manually select or input the initial route location from a list of possible route locations determined by the locator device. While some railroad operations have accepted such human selection of initial track location, newer scenarios such as high speed passenger trains operating at fast speeds (e.g., one hundred twenty five miles per hour or faster) may not be able to safely operate even with human selection of the initial route location given human error.

To eliminate or reduce reliance on human error, the control system may restrict movement of vehicles unless or until the confidence measurement of the location calculated by the locator device exceeds the confidence threshold. This can remove or reduce the human error involved in inputting an initial route location determination. The control system can automatically identify the route location and, once this location is identified with sufficiently high confidence, the control system onboard the vehicle can permit the vehicle to operate with speeds designated for the route (e.g., the PTC system speed limits and PTC system bulletins). When the onboard control system automatically determines the location but without a high enough confidence level, the onboard control system can allow the vehicle to operate or move with guidance or signals provided by the off-board control system (e.g., PTC), but will hold or restrict the vehicle to a restricted speed limit. This speed limit may be slower than other preexisting speed limits of the route, which allows the operator(s) onboard the vehicle to stop the vehicle within a designated stopping distance, such as half the distance of vision and not to exceed twenty miles per hour.

With the lower confidence selection of a route, the VCS controller or the vehicle controller can select the route in a route database (e.g., the memory 224) having the lowest or a lower cross route error to the location identified by the locator device as the route on which the vehicle is located. The cross route error may be a measurement of the number of other nearby routes that are within the error range 326, 426, 526 of the determined location. The VCS controller can communicate this selected route to the VCS back office system and can receive signals from the back office system to determine permissible or impermissible movements by the vehicle, as described above. The locator device can repeatedly determine the location and confidence measurement of the determined locations as the vehicle moves in the restricted mode. If the confidence measurement eventually exceeds the confidence threshold, then the VCS controller and/or the vehicle controller can switch the operational mode to the unrestricted mode. This allows the vehicle to move at faster speeds, such as legal or regulatory speed limits, rated track speeds, etc.

The VCS controller or the vehicle controller can update the initial route selection. For example, a route may be selected using a location with a low confidence measurement (e.g., lower than the confidence threshold). If the confidence measurement for a later determined location exceeds the confidence threshold, then the VCS controller or the vehicle controller can refer again to the route database and select the same or a different route as the route on which the vehicle is currently located. The VCS controller or the vehicle controller can then report this higher-confidence route selection to the back office system. This can help ensure that the back office system has an accurate location and route occupation of the vehicle to ensure that the signals sent by the back office system will result in the safe and efficient movement of the vehicle.

Optionally, the VCS controller and/or the vehicle controller can receive an operator selection of the route on which the vehicle is located. This may occur while the confidence measurement is too low (e.g., below the confidence threshold). The VCS controller and/or the vehicle controller can switch or keep the vehicle operating in the restricted mode unless or until the confidence measurement of a subsequently determined location exceeds the confidence threshold.

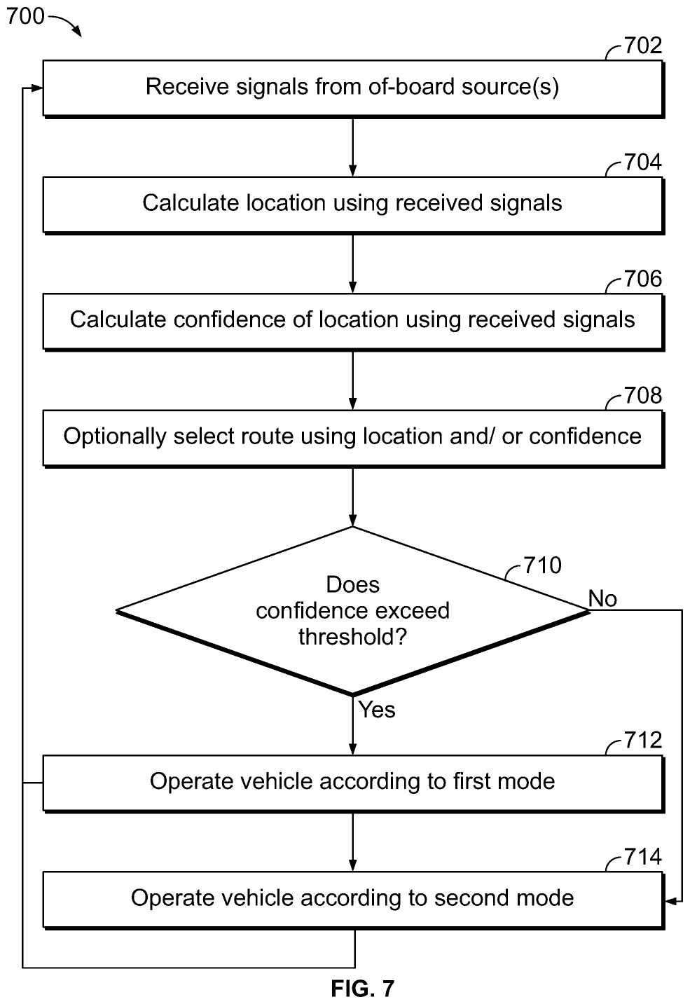

FIG. 7 illustrates a flowchart of one example of a method 700 for controlling operation of a vehicle. The method can represent operations performed by the control system(s) described herein. At step 702, signals are received from off-board sources. For example, the locator device onboard the vehicle can receive GNSS signals from satellites. Optionally, the locator device can receive signals from transponders, transceivers, beacons, or the like, that providing timing information or other information that can be used by the locator device to calculate or otherwise determine locations of the locator device and vehicle.

At step 704, the location of the locator device and vehicle is determined using the signals received from the off-board source(s). For example, the locator device may calculate the location of the locator device using the information contained in the GNSS signals. At step 706, a confidence of the location that was calculated is also calculated. The confidence or confidence measurement can have a value that indicates the range or size of potential error in the location. Optionally, the method may include step 708 that includes selecting a route using the location and/or the confidence that is or are calculated. For example, the route on which the vehicle is located may be selected using the location that is calculated, as described above. The route may be automatically selected by the VCS controller and/or vehicle controller using the calculated location. Optionally, an operator may be provided with two or more potential routes based on the location that is calculated (e.g., the nearest routes to that location), and the operator may select one of these routes. As another example, the operator may be provided with the potential routes that are within the error range (defined by the calculated confidence) of the calculated location for selection.

At step 710, a decision is made as to whether the confidence exceeds a threshold. The confidence that is calculated (the confidence measurement) can be compared to the confidence threshold. Confidence measurements that exceed the threshold may indicate that the calculated location of the vehicle is accurate enough to trust with determining which route the vehicle is located on. Optionally, confidence measurements that exceed the threshold may indicate that the calculated location of the vehicle is accurate enough to allow the vehicle to move at faster speeds and/or with shorter required stopping distances without increasing the risk of accidents or collisions. Conversely, if the confidence measurement does not exceed the threshold, then this can indicate that the location that is calculated may not be accurate enough (or the potential error too large) to rely on automatic route selection or permitting the vehicle to operate at faster speeds and/or with shorter required stopping distances.

If the confidence exceeds the threshold, then flow of the method can proceed toward step 712. At step 712, the vehicle is operated according to a first mode. This first mode may be an unrestricted mode. In this mode, the vehicle can be automatically and/or manually controlled to operate at faster speeds and/or with shorter required stopping distances. For example, the vehicle can be allowed to travel at the speed limit of the route (with the speed limit being a preexisting speed limit applicable to vehicles on that route prior to the confidence being calculated or compared with a threshold). Flow of the method may then terminate or return to a prior operation, such as step 702.

If the confidence does not exceed the threshold, then flow of the method can proceed toward step 714. At step 714, the vehicle is operated according to a second mode. This second mode may be a restricted mode. In this mode, the vehicle can be automatically restricted or prevented from operating at the faster speeds and/or with the shorter required stopping distances of the first mode or unrestricted mode. For example, the vehicle can be prevented from moving at a reduced speed limit that is slower than the preexisting speed limit of the route. Flow of the method may then terminate or return to a prior operation, such as step 702. This can allow for further checks on the error range of the location to be performed and allow the mode to switch back to the unrestricted mode.

In one example, a method for controlling operation of a vehicle system may include identifying a location of the vehicle system and a confidence measurement of the location that is identified, selecting an operational mode of the vehicle system from among a more restrictive operational mode and a less restrictive operational mode based on the confidence measurement of the location that is identified, and controlling movement of the vehicle system within different limits based on which of the more restrictive operational mode or the less restrictive operational mode that is selected.

The movement of the vehicle system can be controlled in the more restrictive operational mode until the confidence measurement of the location exceeds a designated threshold. The movement of the vehicle system can be controlled in the more restrictive operational mode by preventing the vehicle system from moving faster than a first speed limit. The movement of the vehicle system in the less restrictive operational mode can be controlled by preventing the vehicle system from moving faster than a second speed limit that is faster than the first speed limit.

The more restrictive operational mode or the less restrictive operational mode can be selected based on a comparison of the confidence measurement to a designated threshold with the movement of the vehicle system controlled using the less restrictive operational mode responsive to the confidence measurement exceeding the designated threshold and the movement of the vehicle system controlled using the more restrictive operational mode responsive to the confidence measurement not exceeding the designated threshold.

The method also may include changing the designated threshold based on a cargo or absence of a cargo being carried by the vehicle system. The designated threshold can be increased responsive to the vehicle system carrying the cargo that includes passengers or hazardous cargo and the designated threshold is reduced responsive to the vehicle system not carrying the cargo. The designated threshold can be increased responsive to the vehicle system moving through a first geographic area having one or more of a first population density, a first vehicular traffic density, or a first number of route intersections that exceeds a population threshold and the designated threshold is reduced responsive to the vehicle system moving through a second geographic area having one or more of a second population density, a second vehicular traffic density, or a second number of route intersections that does not exceed the population threshold.

The designated threshold can be increased responsive to a nearest other route to the route on which the vehicle system is located being within a threshold distance and the designated threshold is decreased responsive to the nearest other route to the route on which the vehicle system is located not being within the threshold distance.

The movement of the vehicle system can be controlled within the limits of the more restrictive operational mode for up to a designated distance until requiring the confidence measurement to increase above a designated threshold before allowing the movement of the vehicle system any further. The location of the vehicle system that is identified can be an identity of a route from among several routes on which the vehicle system is located. The location of the vehicle system can be automatically identified. The confidence measurement can be selected from among plural different confidence measurements that are measured at different positions of the vehicle system.

In another example, a control system can include one or more processors that can receive or determine a location of a vehicle system and a confidence measurement of the location that is received or determined. The processor(s) can select either a more restrictive operational mode or a less restrictive operational mode for the vehicle based on the confidence measurement. The processor(s) can restrict movement of the vehicle system within different limits based on which of the more restrictive operational mode or the less restrictive operational mode that was selected.

The processor(s) can select the more restrictive operational mode or the less restrictive operational mode by comparing the confidence measurement to a designated threshold, wherein the one or more processors are configured to change the designated threshold based on one or more vehicle parameters or environmental parameters. The processor(s) can change the designated threshold based on a cargo or absence of a cargo being carried by the vehicle system. The processor(s) can change the designated threshold based on a population density, a vehicular traffic density, or a number of route intersections. The processor(s) can change the designated threshold based on a neighboring route not being within a threshold distance of the vehicle.

The processor(s) can restrict the movement of the vehicle system within the limits of the more restrictive operational mode for a designated distance before requiring the confidence value to increase above a designated threshold before allowing the movement of the vehicle system to continue. The processor(s) can receive different values of the confidence measurement from different sources at different positions onboard the vehicle system. The processor(s) can select a higher value of the different values of the confidence measurement for selecting the more restrictive operational mode or the less restrictive operational mode.

In another example, another method for controlling a vehicle system can include calculating a confidence value of an identified location of a vehicle. The confidence value can indicate a certainty that the vehicle is at the identified location. The method can include selecting a first operational mode or a second operational mode based on the confidence value, and restricting movement of the vehicle to within different limits based on which of the first operational mode or the second operational mode was selected.

While one or more embodiments are described in connection with a rail vehicle system, not all embodiments are limited to rail vehicle systems. Unless expressly disclaimed or stated otherwise, the subject matter described herein extends to other types of vehicle systems, such as automobiles, trucks (with or without trailers), buses, marine vessels, aircraft, mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy).

In one example, a method (e.g., for initializing a vehicle for movement under or with the protection of a vehicle control system) is provided. The method may include determining a sensed location of a vehicle based off one or more location signals received from an off-board source, and calculating a calculated location of the vehicle responsive to the vehicle moving into a blocking structure where the vehicle does not determine the sensed location of the vehicle based off the one or more location signals. The calculated location of the vehicle may be calculated using one or more sensor outputs. The method also may include selecting a route from among several routes within the blocking structure based on the calculated location, communicating the route that is selected to a back-office system, and controlling movement of the vehicle using one or more control signals received from the back-office system that are based on the route that is selected.

The one or more location signals may be GNSS signals received from one or more GNSS satellites as the off-board source. The calculated location may be calculated using a dead reckoning calculation. The calculated location may be calculated using one or more of vehicle speeds, vehicle vibrations, and/or vehicle headings as the one or more sensor outputs. Optionally, the method also may include sensing movement of the vehicle using an onboard inertial measurement unit to obtain the one or more sensor outputs.

The vehicle may be unable to receive the one or more location signals while the vehicle is in the blocking structure. The calculated location may be calculated as the stopping location of the vehicle from a first trip and as a starting location for a subsequent second trip. The route that is selected may be selected by identifying the several routes that are within an error range around the calculated location.

The route that is selected may be automatically selected based on the calculated location. The method optionally may include presenting the several routes to an operator of the vehicle and receiving a selection of the route that is selected based on the several routes being presented.

In one example, a system (e.g., a vehicle control system) is provided. The system may include one or more controllers that may determine a sensed location of a vehicle based off one or more location signals received from an off-board source. The one or more controllers may calculate a calculated location of the vehicle responsive to the vehicle moving into a blocking structure where the vehicle does not determine the sensed location of the vehicle based off the one or more location signals. The calculated location of the vehicle may be calculated using one or more sensor outputs. The one or more controllers may select a route from among several routes within the blocking structure based on the calculated location and to communicate the route that is selected to a back office system and may control movement of the vehicle using one or more control signals received from the back office system that are based on the route that is selected.

Optionally, the one or more controllers may receive the one or more location signals as GNSS signals received from one or more GNSS satellites as the off-board source. The one or more controllers may calculate the calculated location using a dead reckoning calculation. The one or more controllers may calculate the calculated location using one or more of vehicle speeds, vehicle vibrations, and/or vehicle headings as the one or more sensor outputs.

The system optionally may include an onboard inertial measurement unit that may output sensed movement of the vehicle as the one or more sensor outputs and/or a locator device that may receive the one or more location signals while the vehicle is outside the blocking structure but unable to receive the one or more location signals while the vehicle is in the blocking structure.

The one or more controllers may calculate the calculated location as a stopping location of the vehicle from a first trip and as a starting location for a subsequent second trip. The one or more controllers may select the route by identifying the several routes that are within an error range around the calculated location. The one or more controllers may automatically select the route that is selected based on the calculated location. The one or more controllers may direct presentation of the several routes to an operator of the vehicle and may receive a selection of the route that is selected based on the several routes being presented.

In one example, a method may include determining sensed locations of a vehicle while the vehicle receives GNSS signals, sensing movement of the vehicle using one or more inertial measurement sensors, calculating one or more calculated locations of the vehicle based on at least one of the sensed locations and the movement of the vehicle that is sensed using the one or more inertial measurement sensors and responsive to no longer receiving the GNSS signals, selecting a route from several different routes as a beginning route for a trip of the vehicle (where the beginning route is selected based on the one or more calculated locations), initializing the vehicle for the trip by communicating the beginning route of the vehicle to an off-board system of a positive control system, and controlling movement of the vehicle based on one or more control signals received from the off-board system responsive to initializing the vehicle for the trip.

In one embodiment, the controllers or systems described herein may have a local data collection system deployed and may use machine learning to enable derivation-based learning outcomes. The controllers may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used making determinations, calculations, comparisons and behavior analytics, and the like.

In one embodiment, the controllers may include a policy engine that may apply one or more policies. These policies may be based at least in part on characteristics of a given item of equipment or environment. With respect to control policies, a neural network can receive input of a number of environmental and task-related parameters. These parameters may include, for example, operational input regarding operating equipment, data from various sensors, location and/or position data, and the like. The neural network can be trained to generate an output based on these inputs, with the output representing an action or sequence of actions that the equipment or system should take to accomplish the goal of the operation. During operation of one embodiment, a determination or calculation can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models is obtained, it may be evaluated on its performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

Use of phrases such as “one or more of . . . and,” “one or more of . . . or,” “at least one of . . . and,” and “at least one of . . . or” are meant to encompass including only a single one of the items used in connection with the phrase, at least one of each one of the items used in connection with the phrase, or multiple ones of any or each of the items used in connection with the phrase. For example, “one or more of A, B, and C,” “one or more of A, B, or C,” “at least one of A, B, and C,” and “at least one of A, B, or C” each can mean (1) at least one A, (2) at least one B, (3) at least one C, (4) at least one A and at least one B, (5) at least one A, at least one B, and at least one C, (6) at least one B and at least one C, or (7) at least one A and at least one C.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A method, comprising:
identifying a location of a vehicle system and a confidence measurement of the location that is identified;
selecting an operational mode of the vehicle system from among a more restrictive operational mode and a less restrictive operational mode based on the confidence measurement of the location that is identified; and
controlling movement of the vehicle system within different limits based on which of the more restrictive operational mode or the less restrictive operational mode that is selected.

2. The method of claim 1, wherein the movement of the vehicle system is controlled in the more restrictive operational mode until the confidence measurement of the location exceeds a designated threshold.

3. The method of claim 1, wherein controlling the movement of the vehicle system in the more restrictive operational mode includes preventing the vehicle system from moving faster than a first speed limit and controlling the movement of the vehicle system in the less restrictive operational mode includes preventing the vehicle system from moving faster than a second speed limit that is faster than the first speed limit.

4. The method of claim 1, wherein the more restrictive operational mode or the less restrictive operational mode is selected based on a comparison of the confidence measurement to a designated threshold with the movement of the vehicle system controlled using the less restrictive operational mode responsive to the confidence measurement exceeding the designated threshold and the movement of the vehicle system controlled using the more restrictive operational mode responsive to the confidence measurement not exceeding the designated threshold.

5. The method of claim 4, further comprising:
changing the designated threshold based on a cargo or absence of a cargo being carried by the vehicle system.

6. The method of claim 5, wherein the designated threshold is increased responsive to the vehicle system carrying the cargo that includes passengers or hazardous cargo and the designated threshold is reduced responsive to the vehicle system not carrying the cargo.

7. The method of claim 5, wherein the designated threshold is increased responsive to the vehicle system moving through a first geographic area having one or more of a first population density, a first vehicular traffic density, or a first number of route intersections that exceeds a population threshold and the designated threshold is reduced responsive to the vehicle system moving through a second geographic area having one or more of a second population density, a second vehicular traffic density, or a second number of route intersections that does not exceed the population threshold.

8. The method of claim 5, wherein the designated threshold is increased responsive to a nearest other route to the route on which the vehicle system is located being within a threshold distance and the designated threshold is decreased responsive to the nearest other route to the route on which the vehicle system is located not being within the threshold distance.

9. The method of claim 1, wherein the movement of the vehicle system is controlled within the limits of the more restrictive operational mode for up to a designated distance until requiring the confidence measurement to increase above a designated threshold before allowing the movement of the vehicle system any further.

10. The method of claim 1, wherein the location of the vehicle system that is identified is an identity of a route from among several routes on which the vehicle system is located.

11. The method of claim 10, wherein the location of the vehicle system is automatically identified.

12. The method of claim 1, wherein the confidence measurement is selected from among plural different confidence measurements that are measured at different positions of the vehicle system.

13. A control system, comprising:
one or more processors configured to receive or determine a location of a vehicle system and a confidence measurement of the location that is received or determined, the one or more processors configured to select either a more restrictive operational mode or a less restrictive operational mode for the vehicle based on the confidence measurement, the one or more processors configured to restrict movement of the vehicle system within different limits based on which of the more restrictive operational mode or the less restrictive operational mode that was selected.

14. The control system of claim 13, wherein the one or more processors are configured to select the more restrictive operational mode or the less restrictive operational mode by comparing the confidence measurement to a designated threshold, wherein the one or more processors are configured to change the designated threshold based on one or more vehicle parameters or environmental parameters.

15. The control system of claim 14, wherein the one or more processors are configured to change the designated threshold based on a cargo or absence of a cargo being carried by the vehicle system.

16. The control system of claim 14, wherein the one or more processors are configured to change the designated threshold based on a population density, a vehicular traffic density, or a number of route intersections.

17. The control system of claim 14, wherein the one or more processors are configured to change the designated threshold based on a neighboring route not being within a threshold distance of the vehicle.

18. The control system of claim 13, wherein the one or more processors are configured to restrict the movement of the vehicle system within the limits of the more restrictive operational mode for a designated distance before requiring the confidence value to increase above a designated threshold before allowing the movement of the vehicle system to continue.

19. The control system of claim 13, wherein the one or more processors are configured to receive different values of the confidence measurement from different sources at different positions onboard the vehicle system, the one or more processors configured to select a higher value of the different values of the confidence measurement for selecting the more restrictive operational mode or the less restrictive operational mode.

20. A method, comprising:
calculating a confidence value of an identified location of a vehicle, the confidence value indicating a certainty that the vehicle is at the identified location;
selecting a first operational mode or a second operational mode based on the confidence value; and
restricting movement of the vehicle to within different limits based on which of the first operational mode or the second operational mode was selected.
